(19) United States
(12) Patent Application Publication
(10) Pub. No.: US 2024/0393076 A1
(43) Pub. Date: Nov. 28, 2024

(54) MUZZLE FLASH SIMULATOR AND LIGHT TRACK GENERATION METHOD

(71) Applicant: SANGTIAN TECHNOLOGY (SHENZHEN) CO., LTD, SHENZHEN CITY (CN)

(72) Inventor: SHUXI XU, SHENZHEN CITY (CN)

(21) Appl. No.: 18/393,561

(22) Filed: Dec. 21, 2023

(30) Foreign Application Priority Data
May 27, 2023 (CN) 202310613377.3
Oct. 30, 2023 (CN) 202311435439.2

(51) Int. Cl. F41A 33/02; F21V 33/00

(52) U.S. Cl. CPC F41A 33/02; F21V 33/008; F41B 11/71

(57) ABSTRACT

A muzzle flash simulator and a light track generation method are provided. The muzzle flash simulator includes: a base; a vibration sensor disposed on the base and communicatively connected to a controller and configured to transmit a trigger signal to the controller when the toy air gun is detected in a vibrating state, in which the controller is preset to output at least two control signals that periodically change according to the trigger signal; and at least one group of flash simulation light sources connected to the controller and configured to periodically emit lights having different colors to a projectile launched from the toy air gun according to the control signals to form a light track.

### FIELD OF THE DISCLOSURE

The present disclosure relates to the technical field of toy gun accessories, and more particularly to a muzzle flash simulator and a light track generation method.

### BACKGROUND OF THE DISCLOSURE

Currently, when playing Airsoft games, in order to simulate the muzzle flash effect of a real gun or to facilitate the observation of the flight trajectory of the projectile, a muzzle flash simulator for a toy gun is often used. The flash simulation light source on the muzzle flash simulator is used to illuminate the flight trajectory of the projectile, or the ultraviolet lamp of a luminous charger is used to illuminate the luminous projectile that can absorb light energy, so that the luminous projectile continues to emit luminous light for a short period of time after leaving the luminous charger, thereby achieving the purpose of displaying the flight trajectory of the projectile.

However, traditional muzzle flash simulators usually have a single color and a single effect, and require the use of luminous projectile to produce a luminous effect, which is expensive.

### SUMMARY OF THE DISCLOSURE

Based on this, it is necessary to provide a muzzle flash simulator and a light track generation method to solve the above technical problems, so as to solve the problem in the existing technology that the light track has a single color and requires a use of luminous projectile to produce a luminous effect, thus leading to the problem of higher costs.

In order to achieve the above-mentioned purpose, the present disclosure provides a muzzle flash simulator configured to be installed on a toy air gun. The muzzle flash simulator includes: a base; a vibration sensor installed on the base and communicatively connected with a controller and configured to send a trigger signal to the controller when the toy air gun is detected in a vibrating state, in which the controller is preset to output at least two control signals that periodically change according to the trigger signal; and at least one group of flash simulation light sources connected to the controller is configured to periodically emit lights having different colors to a projectile launched from the toy air gun according to the control signal to form a light track.

In preferred embodiments, a rail structure is provided on the base, and the muzzle flash simulator is configured to be detachably installed on the toy air gun through the rail structure.

In preferred embodiments, the rail structure is provided on a side of the base, and a protruding structure matching the rail structure is provided on a side of the toy air gun.

In preferred embodiments, a threaded structure is provided on the base, and the muzzle flash simulator is configured to be detachably installed at a muzzle of the toy air gun through the threaded structure.

In preferred embodiments, the at least one group of flash simulation light sources includes at least one group of light-emitting elements, and each of the at least one group of light-emitting elements includes at least two light-emitting elements having different colors. The controller includes a signal generator circuit preset to output the at least two control signals that periodically change to correspondingly control turn-on, turn-off and luminous brightness of the at least two light-emitting elements having different colors.

In preferred embodiments, a ratio of a positive voltage duration of the control signal to a period within a cycle is constant.

In preferred embodiments, the positive voltage duration is calculated by the following formula:

$$3 T / 2 n$$

in which T is the period, T is less than 0.1 seconds, n is a number of colors of the light-emitting elements, and n is greater than 1.

In preferred embodiments, a phase difference between two adjacent control signals is calculated by the following formula:

$$360 ° / n$$

in which n is a number of colors of the light-emitting elements, and n is greater than 1.

In order to achieve the above-mentioned purpose, the present disclosure further provides a light track generation method applied to the aforementioned muzzle flash simulator, including: when the toy air gun is detected in the vibrating state, the vibration sensor is configured to generate the trigger signal and transmit the trigger signal to the controller; the controller is preset to generate and output the at least two control signals that periodically change according to the trigger signal; and the at least one group of flash simulation light sources is configured to receive the control signal and periodically emit lights having different colors to the projectile launched from the toy air gun according to the control signal, so as to generate a corresponding light track according to a flight trajectory of the projectile.

In preferred embodiments, the steps of generating the trigger signal and transmitting the trigger signal to the controller includes: determining whether or not the toy air gun launches the projectile; and if yes, generating the trigger signal and transmitting the trigger signal to the controller.

In the present disclosure, the muzzle flash simulator and the light track generation method are provided. The muzzle flash simulator is configured to be installed on the toy air gun and includes: the base; the vibration sensor installed on the base and communicatively connected with the controller and configured to transmit the trigger signal to the controller when the toy air gun is detected in the vibrating state, in which the controller is preset to output the at least two control signals that periodically change according to the trigger signal; and the at least one group of flash simulation light sources connected to the controller and configured to periodically emit lights having different colors to the projectile launched from the toy air gun according to the control signal to form the light track. In the present disclosure, when the toy air gun launches the projectile, due to a violent impact of an internal mechanism of the toy air gun, a barrel and other parts vibrate, causing the vibration sensor to be triggered, and then the projectile flies away from the muzzle flash simulator. When the controller receives the trigger signal of the vibration sensor, the controller is preset to generate the control signal to control the flash simulation light source to emit lights having different colors to the projectile. Through a reflection against the projectile, a long light track including a small light track of different colors is connected in series in the air to produce a mixed colorful effect, so that a control software can be simplified, and a performance requirement of the controller can be reduced. Therefore, the need to use a luminous projectile can be eliminated, and cost can be lowered.

### BRIEF DESCRIPTION OF THE DRAWINGS

In order to explain the embodiments of the present disclosure or the technical solutions in the prior art more clearly, the drawings needed to be used in the description of the embodiments or the prior art will be briefly introduced below. Obviously, the drawings in the following description are only some embodiments of the present disclosure. For those of ordinary skill in the art, other drawings can be obtained based on these drawings without exerting any creative effort.

FIG. 1 is a schematic structural diagram of an assembly of a toy air gun and a muzzle flash simulator according to one embodiment of the present disclosure;

FIG. 2 is a schematic module diagram of the muzzle flash simulator according to one embodiment of the present disclosure;

FIG. 3 is a first schematic structural diagram of the muzzle flash simulator according to one embodiment of the present disclosure;

FIG. 4 is a second schematic structural diagram of the muzzle flash simulator according to one embodiment of the present disclosure;

FIG. 5 is a first schematic left side view of the muzzle flash simulator according to one embodiment of the present disclosure;

FIG. 6 is a second schematic left side view of the muzzle flash simulator according to one embodiment of the present disclosure;

FIG. 7 is a third schematic left side view of the muzzle flash simulator according to one embodiment of the present disclosure;

FIG. 8 is a schematic fourth left side view of the muzzle flash simulator according to one embodiment of the present disclosure;

FIG. 9 is a schematic diagram of the projectile starting to run according to one embodiment of the present disclosure;

FIG. 10 is a schematic diagram showing the projectile running in the projectile channel 21 is detected according to one embodiment of the present disclosure;

FIG. 11 is a schematic diagram showing a generation of a light track after the projectile flies away from the projectile channel 21 according to one embodiment of the present disclosure;

FIG. 12 a signal waveform diagram showing three waveforms of the control signals according to one embodiment of the present disclosure;

FIG. 13 is a signal waveform diagram showing three different control signals correspondingly output by a controller according to one embodiment of the present disclosure;

FIG. 14 is a schematic diagram of a mixed light track in which the controller outputs three different control signals and correspondingly controls the luminous brightness, turn-on and turn-off of the light-emitting element according to one embodiment of the present disclosure;

FIG. 15 is a schematic diagram showing a periodic mixing of light tracks according to one embodiment of the present disclosure; and

FIG. 16 is a schematic flowchart of a light track generation method according to one embodiment of the present disclosure.

### DETAILED DESCRIPTION OF THE EXEMPLARY EMBODIMENTS

The technical solutions in the embodiments of the present disclosure will be clearly and completely described below with reference to the accompanying drawings in the embodiments of the present disclosure. Obviously, the described embodiments are part of the embodiments of the present disclosure, not all of them. Based on the embodiments of the present disclosure, all other embodiments obtained by those of ordinary skill in the art without making creative efforts fall within the scope of protection of the present disclosure.

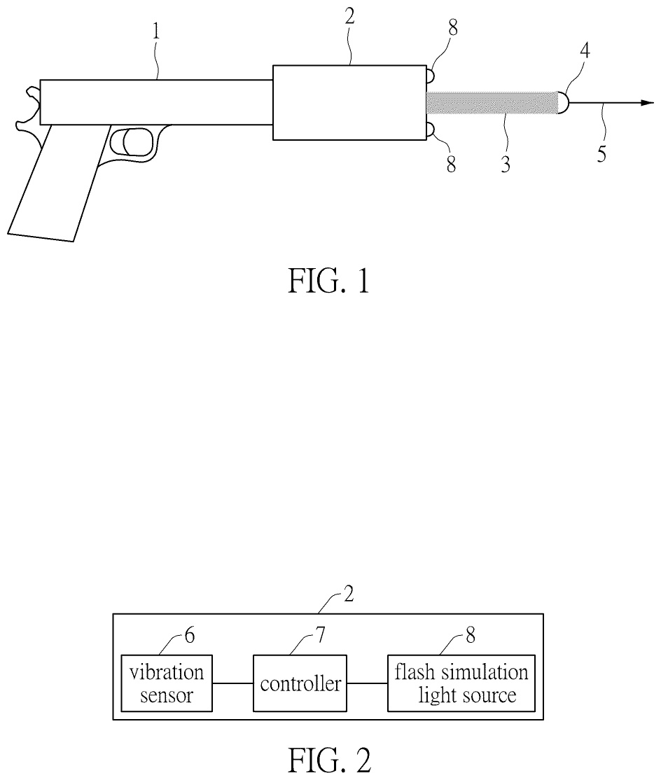

In one embodiment, as shown in FIG. 1 and FIG. 2, a muzzle flash simulator 2 is provided. The muzzle flash simulator 2 is installed on a toy air gun 1 and includes: a base 9; a vibration sensor 6, a controller 7, and at least one group of flash simulation light sources 8. The vibration sensor 6 is disposed on the base 9 and communicatively connected to the controller 7, and configured to transmit a trigger signal to the controller 7 when the toy air gun is detected in a vibrating status. The controller 7 is preset to output at least two control signals that periodically change according to the trigger signal. The at least one group of flash simulation light sources 8 is connected to the controller 7 and configured to periodically emit lights having different colors to the projectile 4 launched from the toy air gun according to the control signals to form a light track 3. In the present disclosure, when the toy air gun launches the projectile, due to a violent impact of an internal mechanism of the toy air gun, a barrel and other parts vibrate, causing the vibration sensor to be triggered, and when a propagation speed of sound is greater than a flight speed of the projectile, the vibration sensor is triggered before the projectile flies away from the flash simulation light source and the trigger signal is generated. When the controller receives the trigger signal of the vibration sensor, the controller generates the control signal to control the flash simulation light source to emit lights having different colors to the projectile. Through a reflection against the projectile, a long light track including a small light track of different colors is connected in series in the air to produce a mixed colorful effect, so that a control software can be simplified and a performance requirement of the controller can be reduced. Therefore, the need to use a luminous projectile can eliminated, and cost can be lowered.

The toy air gun 1 can be one of a toy gun, a BB gun, a foam dart blaster, a gel ball gun, an air BB gun, an airsoft gun, and a paintball gun.

The muzzle flash simulator 2 can adopt a shape of muzzle accessories such as a flash hider, a suppressor, a muzzle brake or a silencer.

The controller 7 can be a PCB control circuit board, on which is provided a control chip such as a MCU and a single-chip microcomputer, and is configured with a corresponding control circuit to achieve electrical connection with the flash simulation light source 8 and the vibration sensor 6, and can control light-emitting color, turn-on and turn-off of the flash simulation light source 8 through the control chip.

The vibration sensor 6 can be a spring switch, a microphone, etc.

Referring to FIG. 3, in the embodiments of the present disclosure, the muzzle flash simulator 2 can be detachably connected to a muzzle of the toy air gun 1, that is, an end of a barrel, for replacement and maintenance at any time. Specifically, the base 9 is provided with a threaded structure 91 through which the muzzle flash simulator 2 can be detachably installed at the muzzle of the toy air gun 1. Specifically, the muzzle of the toy air gun 1 is provided with threads that match the thread structure 91. When in use, the muzzle flash simulator 2 can be detachably installed on the toy air gun 1 through the thread structure 91. The muzzle can be directly disassembled after use. Such structure is simple and easy to assemble.

Further, when an assembly of the muzzle flash simulator 2 and the toy air gun 1 is achieved through the threaded structure 91, the muzzle flash simulator 2 can be provided with a projectile channel 21 for a flight of the projectile 4, and the projectile channel 21 is coaxial with a flight trajectory 5 of the projectile 4. When the muzzle flash simulator 2 is installed at the muzzle of the toy air gun 1, the projectile 4 launched by the toy air gun 1 can be launched to the outside through the projectile channel 21. At this time, the vibration sensor 6 can be disposed in the projectile channel 21, for example, on an inner wall of the projectile channel 21, to detect whether or not the toy air gun 1 vibrates.

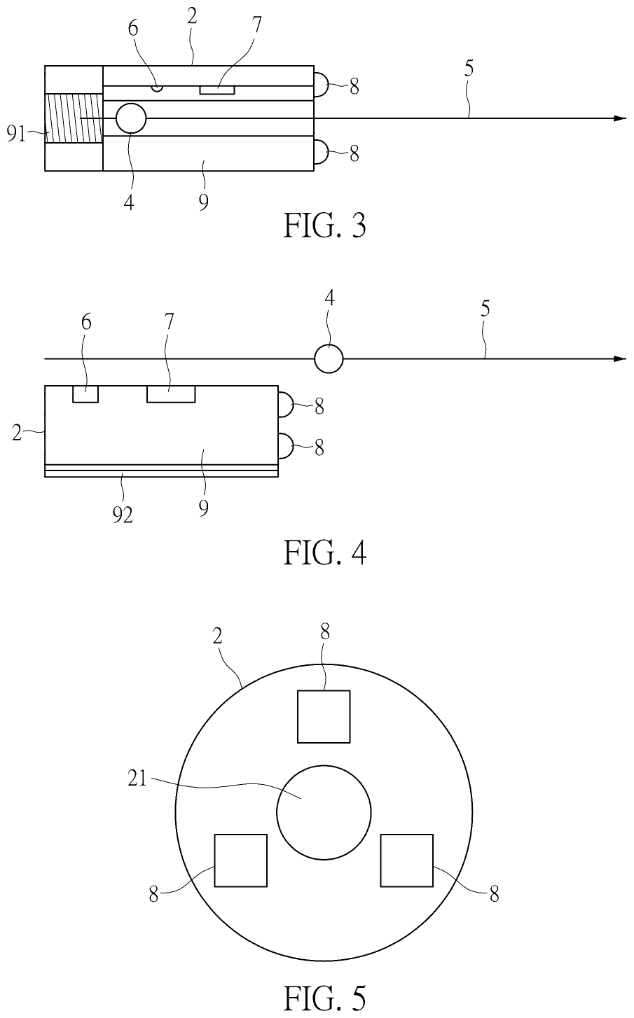

Referring to FIG. 4, in the embodiments of the present disclosure, the base 9 is provided with a rail structure 92 through which the muzzle flash simulator 2 can be detachably installed at the muzzle of the toy air gun 1. Specifically, the rail structure 92 can be provided on a side of the base 9, and a side of the muzzle of the toy air gun 1 is provided with a protruding structure (not shown in the figures) that matches the rail structure 92. The rail structure 92 is provided with a sliding groove (not shown in the figures). When in use, the sliding groove can be used to slide on the protruding structure to achieve assembly. After use, the sliding groove can be used to slide out. Such structure is simple and easy to assemble.

The side of the base 9 can be a left side, a right side, an upper side or a lower side of the base 9. It can be understood that the muzzle flash simulator 2 can be installed on a left side, a right side, an upper side and a lower side of the toy air gun 1. For ease of use, the muzzle flash simulator 2 can be preferably installed on the right side to reduce an obstruction to the toy air gun 1.

Further, when the muzzle flash simulator 2 and the toy air gun 1 are assembled through the rail structure 92, the muzzle flash simulator 2 can be installed on the side of the toy air gun 1, such as the upper side, the lower side, the left side, the right side, etc. At this time, the projectile 4 does not need to pass through the muzzle flash simulator 2, so that there is no need to install the projectile channel 21, and the structure therefore becomes simpler.

In the embodiments of the present disclosure, the flash simulation light source 8 includes at least one group of light-emitting elements, and each group of light-emitting elements may specifically include at least two light-emitting elements having different colors, for example, a first color light-emitting element, a second color light-emitting element, etc. A number of colors of the light-emitting elements is not limited. The greater number of light sources results in the greater luminous brightness. The greater variety of colors of the light-emitting elements results in the mixed colorful colors. The flash simulation light source 8 can periodically change color under the control of the controller 7 and illuminate the projectile 4 that is flying away from the muzzle flash simulator 2 and flying along the flight trajectory 5. A surface of the projectile 4 is used to reflect lights having different colors onto a human body. Due to a visual residual effect of the human eye, richly colored light tracks 5 are displayed in the air.

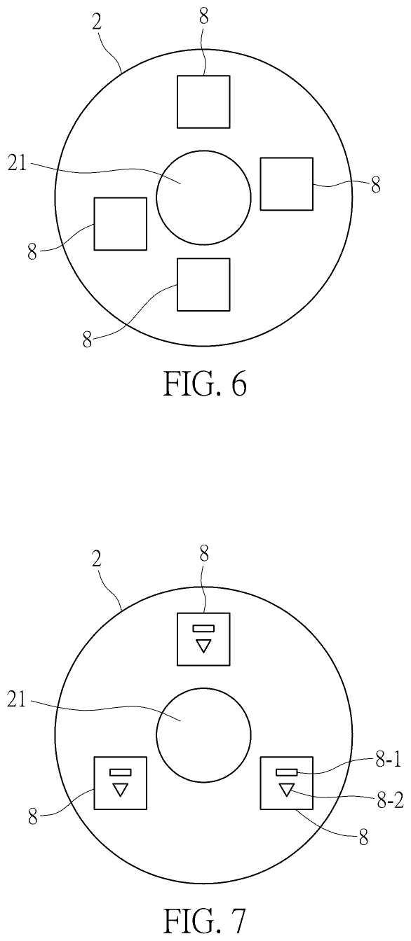

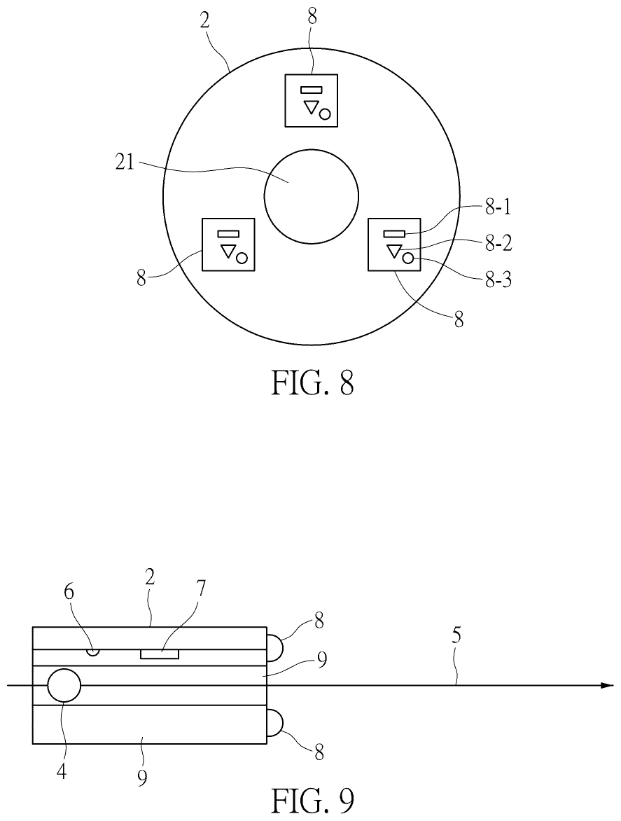

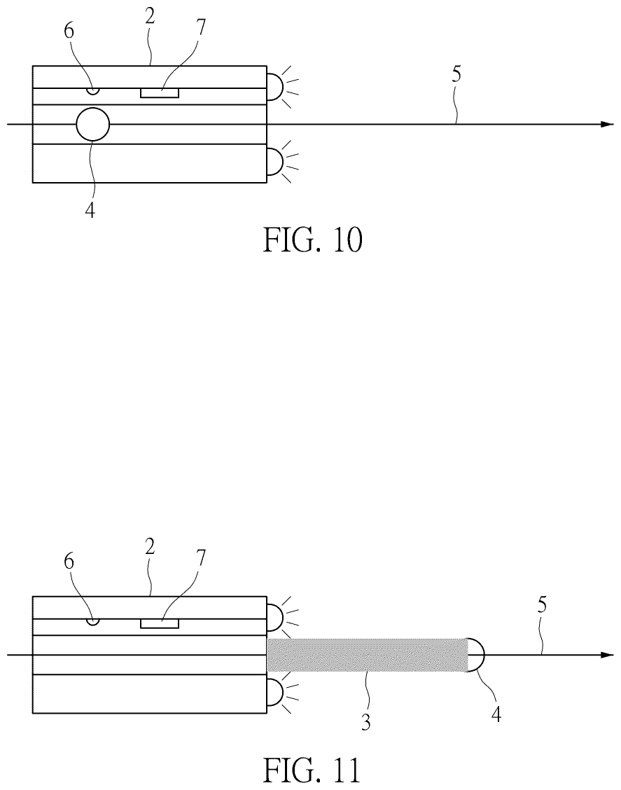

In the embodiments of the present disclosure, the flash simulation light source 8 can be disposed at a front end of the muzzle flash simulator 2, that is, at an end close to the muzzle and located outside the base 9. Reference is made to FIG. 3, in which a schematic structural diagram of three groups of flash simulation light sources 8 is shown. Reference is made to FIG. 4, in which a schematic structural diagram of four groups of flash simulation light sources 8 is shown. The flash simulation light source 8 can be disposed equidistantly around the outside of the projectile channel 21. Each group of flash simulation light sources 8 can be provided with at least two light-emitting elements. Reference is made to FIG. 5 and FIG. 6, in which two light-emitting elements and three light-emitting elements are correspondingly provided in each group of flash simulation light sources 8, which are the first light-emitting element 8-1 and the second light-emitting element 8-2 as shown in FIG. 5, or the first light-emitting element 8-1, the second light-emitting element 8-2 and the third light-emitting element 8-3 as shown in FIG. 6. The first light-emitting element 8-1, the second light-emitting element 8-2 and the third light-emitting element 8-3 can respectively be used to emit lights having different colors, for example, respectively emit red light, blue light, green light, etc.

The light-emitting element can be a light-emitting diode.

In the embodiments of the present disclosure, the controller 7 includes a signal generator circuit configured to output the at least two control signals that periodically change and are correspondingly used to control luminous brightness, turn-on and turn-off of the light-emitting elements having different colors. When the propagation speed of sound is greater than the flight speed of the projectile 4, the vibration sensor 6 will be triggered before the projectile 4 flies away from the flash simulation light source 8. For example, the light-emitting elements include the first color light-emitting element 8-1 and the second color light-emitting element 8-2, and the control signals include a first control signal and a second control signal. Then the first control signal can be used to control the luminous brightness, turn-on and turn-off of the first color light-emitting element 8-1 and the second control signal can be used to control the luminous brightness, turn-on and turn-off of the second color light-emitting element 8-2.

It can be understood that the light-emitting elements may include at least two light-emitting elements having different colors. The greater number of light sources results in the greater luminous brightness achieved. The greater variety of colors of the light-emitting elements results in the mixed colorful colors achieved.

The output signal form of the control signal can be one or any combination of a rectangular wave, a triangular wave or a sine wave. The number of control signals is equal to the number of color types of the light-emitting elements.

In an implementation scenario, the muzzle flash simulator 2 can be installed on the toy air gun during use. When the toy air gun 1 launches the projectile, due to the violent impact of the internal mechanism of the toy air gun 1, the barrel and other parts vibrate, causing the vibration sensor 6 to be triggered, and then the projectile flies away from the muzzle flash simulator 2. When the controller 7 receives the trigger signal transmitted by the vibration sensor 6 and turns on the signal generator to generate the control signals according to the trigger signal, multiple light-emitting elements having different colors generate strong light to illuminate the projectile 4 away from the muzzle flash simulator 2 under the control of the control signals. The strong light is reflected into the human eye through the surface of the projectile 4, and the human eye will observe the flight trajectory of the projectile in the air. Since the control signals generated by the controller 7 change periodically, the luminous effects of the light-emitting elements having different colors change periodically under the control of the control signal while the projectile 4 is flying, and the color of the flight trajectory of the projectile 4 also changes accordingly. Due to the visual residual effect of the human eye, when the period of the control signals generated by the controller 7 is less than the residual time of the human eye's vision, the human eye will simultaneously observe a long light track in the air consisting of small light tracks of different colors connected in series, as if a rainbow.

The signal generator circuit can be a digital signal generator circuit or an analog signal generator circuit. It can be used to output at least two control signals that periodically change to correspondingly control the luminous brightness, turn-on and turn-off of the light-emitting elements having different colors.

Reference is made to FIGS. 9 to 11, when the projectile 4 is launched along the flight trajectory 5, the projectile 4 passes through the projectile channel 21 provided by the muzzle flash simulator 2 along the flight trajectory 5, and flies away from the muzzle flash simulator 2. When the vibration sensor 6 detects vibration of the gun body, the vibration sensor 6 transmits the trigger signal to the controller 7 to turn on an internal signal generator circuit of the controller 7 to generate at least two control signals that periodically change for controlling the flash simulation light source 8 to periodically change color.

In an embodiment of the present disclosure, the control signal output by the controller 7 changes periodically. Preferably, when the controller 7 generates n control signals, each control signal adopts the same signal period. For example, a period of the first control signal is equal to a period of the second control signal, the period of the second control signal is equal to a period of the third control signal . . . , a period of the n−1^{th} control signal is equal to a period of the n^{th} control signal, and n is a positive integer.

In an embodiment of the present disclosure, the control signal output by the controller 7 has a constant ratio between the positive voltage duration and the period within a cycle, that is, the positive voltage duration/T is constant.

Preferably, the following formula is used to calculate the duration of the positive voltage: 3T/2n, where T is the period. Since the residual time is less than 0.1 to 0.4 seconds for human vision, T can be set to less than 0.1 seconds, n is the number of colors of the light-emitting elements, and n is greater than 1.

In an embodiment of the present disclosure, a phase difference between two adjacent control signals of the control signal output by the controller 7 is between 0 and 180°, 180° is included, and can be calculated using the following formula: 360°/n, where n is the number of colors of the light-emitting elements, and n is greater than 1.

It can be understood that when the controller 7 generates n control signals, a phase difference between each adjacent control signal can be 360°/n. For example, a phase difference between the second control signal and the first control signal is 360°/n, a phase difference between the third control signal and the second control signal is 360°/n . . . , a phase difference between the n^{th} control signal and the n−1^{th} control signal is 360°/n, and n is a positive integer.

Since the visual residual time of the human eye is 0.1 seconds to 0.4 seconds, when the control signal period T is less than a lower limit of the human visual residual time, i.e., 0.1 seconds, the human eye can observe the regular luminous effect produced by the muzzle flash simulator within a complete control signal period T.

Referring to FIG. 10, in an embodiment of the present disclosure, different types of signal waveform diagrams are shown when the control signal has the consistent period of T and the positive voltage time of T/2. Given the ordinate is the voltage V and the abscissa is the time t, an order from top to bottom is the waveform diagrams of the positive voltage part for the rectangular wave signal, the triangular wave signal, and the sine wave signal. It is understandable that since the negative voltage signal cannot be used as an effective control signal during actual implementation, a negative voltage part of the signal is not shown on the waveform diagram.

When the control signal can be a rectangular wave signal, the signal voltage has only two values, and the controlled light-emitting elements has only two light-emitting states.

As a preferred embodiment, the control signal can be a triangular wave signal or a sine wave signal. The voltages of the two signals will continue to change with time, so an infinite number of voltages can be generated, and the light-emitting states of the controlled light-emitting elements are countless. There are countless color combinations after mixing the light-emitting elements having different colors, and the colors of the light tracks produced are more colorful.

In the embodiments of the present disclosure, the light track effect simulated by the muzzle flash is rich in color, and multiple color effects can be produced segmentally on the flight trajectory of the same projectile. There are no special requirements for a material of the projectile, which saves usage costs. The light-emitting elements having different colors can be controlled by the signal generator circuit. By presetting the period, phase difference and positive voltage duration of adjacent control signals, a periodically changing multi-channel signal waveform is generated, which is used to control the light-emitting elements having various colors to produce combined mixed colorful effect. The control software can be simplified, the requirements for the controller performance can be reduced, and the projectile needs to be detected, thereby simplifying the structure.

Reference is made to FIG. 11, in which the waveform diagram of the control signal 7-1, the control signal 7-2 and the control signal 7-3 are shown. Given the ordinate is the voltage V, the abscissa is the time t, and V0 is the turn-on voltage of the flash simulation light source 8, the control signal 7-1, the control signal 7-2 and the control signal 7-3 are three sets of rectangular wave signals, the signal period is the same as T, T is less than 0.1 seconds, which are correspondingly used to control the flash simulation light source 8 as shown in FIG. 6. The control signal 7-1 is used to control turn-on and turn-off of the first light-emitting element 8-1, the control signal 7-2 is used to control turn-on and turn-off of the second light-emitting element 8-2, and the control signal 7-3 is used to control turn-on and turn-off of the third light-emitting element 8-3. According to the positive voltage duration calculation formula 3T/2n, the phase difference calculation formula 360°/n and the principle that the number of control signals is equal to the number of colors of the light-emitting elements, it can be seen that n is equal to 3. The calculation shows that the positive voltage duration of the control signal 7-1, the control signal 7-2 and the control signal 7-3 is consistent with T/2, and the phase difference is consistent with 120°, that is, the phase difference between the control signal 7-2 and the control signal 7-1 is 120°. The positive voltage duration period is 0 to 3T/6, the phase difference between the control signal 7-3 and the control signal 7-2 is 120°, the positive voltage duration period is from 2T/6 to 5T/6, the phase difference between the control signal 7-1 and the control signal 7-3 is 120°, and the positive voltage duration is from 4T/6 to the next cycle of T/6.

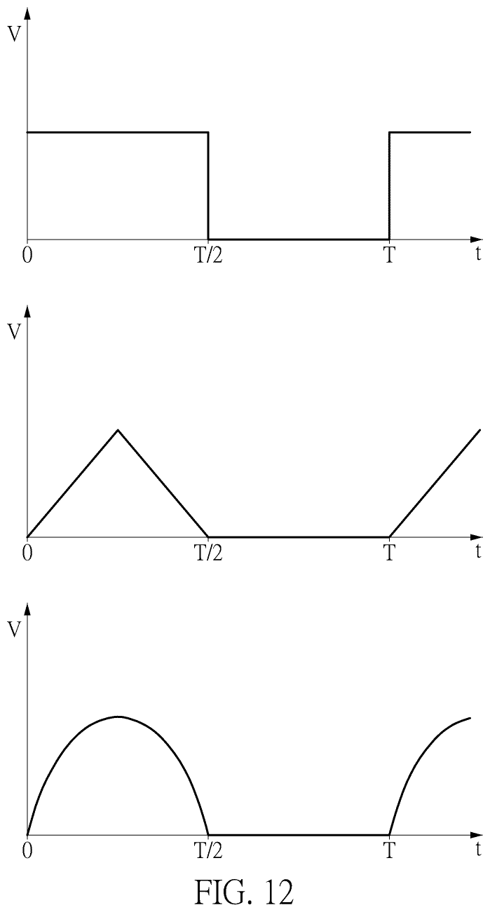

Referring to FIG. 12, when the projectile 4 passes through the muzzle flash simulator 2 and flies along the flight trajectory 5 and away from the muzzle flash simulator 2, the three sets of control signals can show periodic changes, and the colors of the three light-emitting elements having different colors illuminated by the projectile 4 change periodically under the respective control of the three sets of control signals. That is, in the time period from 0 to T/6, since the control signal 7-1 and the control signal 7-3 reach the turn-on voltage V0 of the light-emitting element, the first light-emitting element 8-1 and the second light-emitting element 8-2 are lit to illuminate the projectile 4 flying away from the muzzle flash simulator 2 to generate a light track 3-1 within the time period from T/6 to 2T/6, since the control signal 7-1 reaches the turn-on voltage V0 of the light-emitting element, the first light-emitting element 8-1 is lit to illuminate the projectile 4 flying away from the muzzle flash simulator 2 to generate a light track 3-2 within the time period from 2T/6 to 3T/6, since the control signal 7-1 and the control signal 7-2 reach the turn-on voltage V0 of the light-emitting element, the first light-emitting element 8-1 and the second light-emitting element 8-2 are lit to illuminate the projectile 4 flying away from the muzzle flash simulator 2 to generate a light track 3-3 within the time period from 3T/6 to 4T/6, since the control signal 7-2 reaches the turn-on voltage V0 of the light-emitting element, the second light-emitting element 8-2 is lit to illuminate the projectile 4 flying away from the muzzle flash simulator 2 to generate a light track 3-4 within the time period from 4T/6 to 5T/6, since the control signal 7-2 and the control signal 7-3 reach the turn-on voltage V0 of the light-emitting element, the second light-emitting element 8-2 and the third light-emitting element 8-3 are lit to illuminate the projectile 4 flying away from the muzzle flash simulator 2 to generate a light track 3-5 within the time period from 5T/6 to T, since the control signal 7-3 reaches the turn-on voltage V0 of the light-emitting element, the third light-emitting element 8-3 is lit to illuminate the projectile 4 flying away from the muzzle flash simulator 2 to generate a light track 3-6. At the beginning of the next signal period T, the light track starts to cycle from the light track 3-1, thus forming a long light track 3 with colored short light tracks connected at the beginning and end.

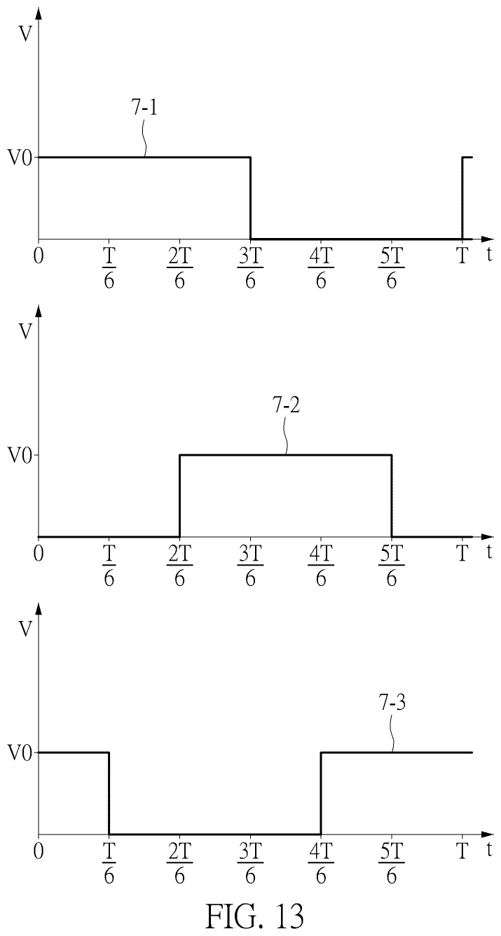

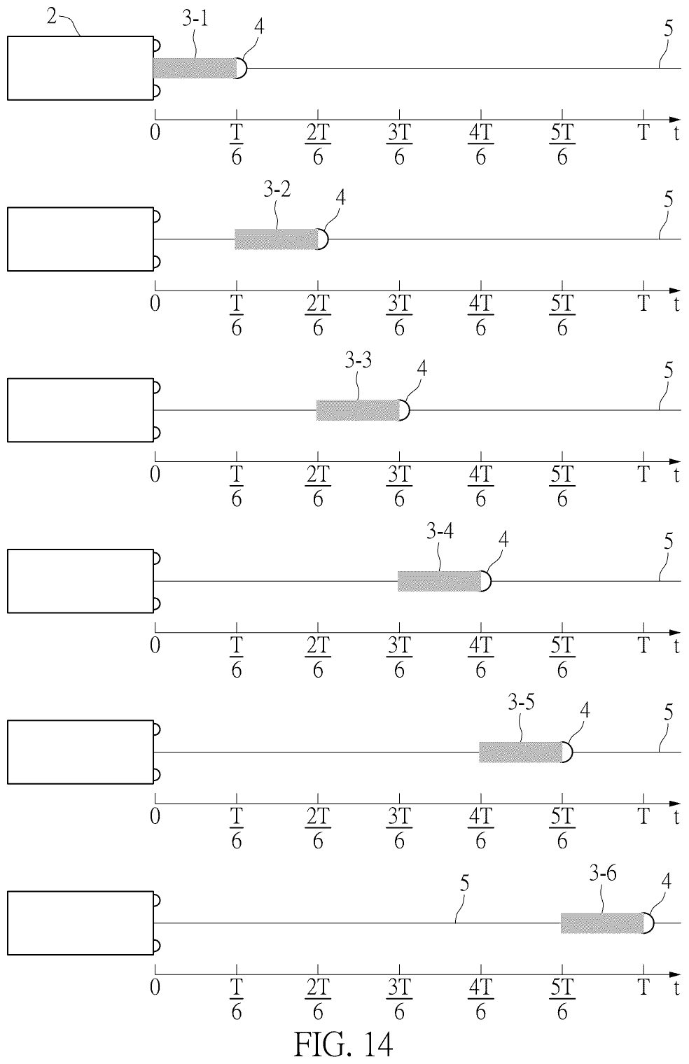

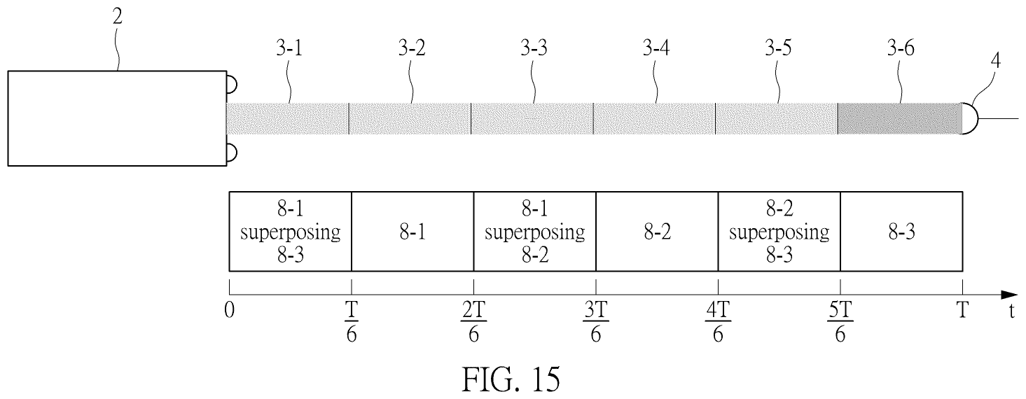

Referring to FIG. 13, the projectile 4 flies at a certain speed and flies away from the muzzle flash simulator 2. The light shining on the surface of the projectile 4 is reflected back and enters the naked eye to form the light track. Due to the visual residual effect of the human eye, the user can observe the light track 3-1, the light track 3-2, the light track 3-3, the light track 3-4, the light track 3-5 and the light track 3-6 that form a continuous light track in the sky at the same time. Since the first light-emitting element 8-1, the second light-emitting element 8-2 and the third light-emitting element 8-3 are light-emitting elements of three different colors, the resulting light tracks 3-1, 3-2, 3-3, 3-4, 3-5 and 3-6 are light tracks of different colors, namely the light track 3-1 is the color of the light generated by superposing the first light-emitting element 8-1 and the third light-emitting element 8-3, the light track 3-2 is the color of the light generated by the first light-emitting element 8-1, the light track 3-3 is the color of the light generated by superposing the first light-emitting element 8-1 and the second light-emitting element 8-2, the light track 3-4 is the color of the light generated by the second light-emitting element 8-2, the light track 3-5 is the color generated by superposing the second light-emitting element 8-2 and the third light-emitting element 8-3, the light track 3-6 is the color of the light generated by the third light-emitting element 8-3. Therefore, in conjunction with FIG. 5 and FIG. 13, in the present disclosure, within the signal period T, the projectile 4, under the illumination of the muzzle flash simulator 2, can generate the long light track 3 including six light tracks of different colors connected at the beginning, as if a rainbow. Therefore, the light track is also called a rainbow light track.

In the embodiments of the present disclosure, when the toy air gun launches the projectile, due to the violent impact of the internal mechanism of the toy air gun, the barrel and other parts vibrate, causing the vibration sensor to be triggered, and then the projectile flies away from the muzzle flash simulator. When the controller receives the trigger signal of the vibration sensor, the controller generates the control signal to control the flash simulation light source to emit lights having different colors to the projectile. Through the reflection against the projectile, a long light track including the small light track of different colors is connected in series in the air to produce the mixed colorful effect, so that the control software can simplified and the performance requirement of the controller is reduced. Therefore, the need to use luminous projectile can be eliminated, and the cost can lowered.

Each module in the above-mentioned muzzle flash simulator can be partially implemented through software, hardware and combinations thereof. Each of the above modules can be embedded in the processor of the computer device in the form of hardware or independent of it, and can be stored in the memory of the computer device in the form of software, so that the processor can invocate and execute the operations corresponding to the above modules.

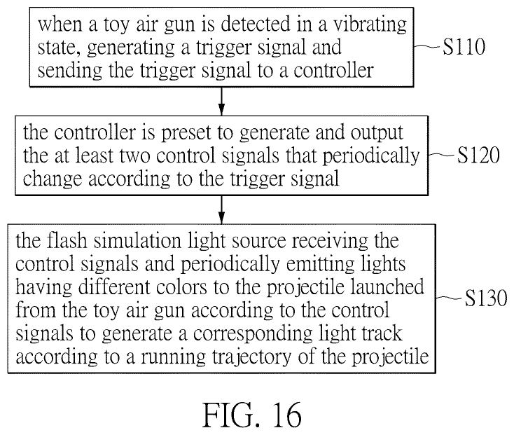

Reference is made to FIG. 16, an implementation flow chart of a light track generation method is provided, which is applied to the muzzle flash simulator and specifically includes the following steps.
S110: when the toy air gun is detected in the vibrating state, the vibration sensor is configured to generate the trigger signal and transmit the trigger signal to the controller;
S120: the controller is preset to generate and output the at least two control signals that periodically change according to the trigger signal;
S130: the flash simulation light source is configured to receive the control signals and periodically emit lights having different colors to the projectile launched from the toy air gun according to the control signals, so as to generate a corresponding light track according to a flight trajectory of the projectile.

In the embodiments of the present disclosure, when the toy air gun launches a projectile, due to the violent impact of the internal mechanism of the toy air gun, the barrel and other parts vibrate, causing the vibration sensor to be triggered, and then the projectile flies away from the muzzle flash simulator. When the controller receives the trigger signal sent by the vibration sensor and turns on the signal generator to generate the control signals according to the trigger signal, the multiple light-emitting elements having different colors generate strong light to illuminate the projectile away from the muzzle flash simulator under the control of the control signals. The strong light is reflected into the human eye through the surface of the projectile, and the human eye will observe the flight trajectory of the projectile in the air. Since the control signals generated by the controller change periodically, the luminous effects of the light-emitting elements having different colors change periodically under the control of the control signals while the projectile is flying, and the color of the flight trajectory of the projectile also changes accordingly. Due to the visual residual effect of the human eye, when the period of the control signals generated by the controller is less than the residual time of the human eye's vision, the human eye will simultaneously observe a long light track in the air consisting of small light tracks of different colors connected in series, as if a rainbow.

In the embodiments of the present disclosure, the steps of outputting at least two control signals that periodically change includes: presetting the period, phase difference and positive voltage duration of the control signal to generate and output at least two control signals that periodically change according to the trigger signal.

Specifically, different types of toy air guns, as well as different types of projectile, lead to different flight trajectories of projectile. For example, flight height, flight length, flight arc, etc., are different. Therefore, when configuring the control signals, the type of toy air gun and the type of projectile launched can be obtained and used to preset the corresponding period, phase difference and positive voltage duration so that the light track can meet the flight trajectories of different projectiles.

In an embodiment of the present disclosure, the steps of generating the trigger signal and transmitting the trigger signal to the controller includes: determining whether or not the toy air gun launches the projectile; or if yes, generating the trigger signal and transmitting the trigger signal to the controller.

Specifically, due to environmental influences or artificial vibrations, the vibration sensor may mistakenly trigger the light-emitting element to emit light. When the toy air gun is detected in the vibrating state, it can be further determined whether the toy air gun launches the projectile. For example, when the last vibration was generated, whether or not the projectile was launched, and if yes, the trigger signal can be generated and transmitted to the controller.

The projectile sensor, such as a Hall sensor or an infrared sensor, can be provided to detect whether the projectile is launched and to detect whether or not the projectile passes through.

Furthermore, a sensitivity of the vibration sensor can be reduced so that it is only triggered by severe vibrations of the gun body, or an anti-interference circuit can be used to shield a specific range of vibrations to eliminate environmental interference to the sensor.

In the embodiment of the present disclosure, when the toy air gun launches the projectile, due to the violent impact of the internal mechanism of the toy air gun, the barrel and other parts vibrate, causing the vibration sensor to be triggered, and then the projectile flies away from the muzzle flash simulator. When the controller receives the trigger signal of the vibration sensor, the controller generates the control signals to control the flash simulation light source to emit lights having different colors to the projectile. Through the reflection against the projectile, the long light track including the small light track of different colors is connected in series in the air to produce the mixed colorful effect, so that the control software can simplified and the performance requirement of the controller can be reduced. Therefore, the need to use luminous projectile can be eliminated, and the cost can be lowered.

It should be understood that the sequence number of each step in the above embodiment does not mean the order of execution. The execution order of each process should be determined by its function and projectile logic, and should not constitute any limitation on the implementation process of the embodiment of the present disclosure.

Those skilled in the art can clearly understand that for the convenience and simplicity of description, it is exemplified only in terms of the functional units and modules mentioned above. In actual applications, the above functions can be allocated to different functional units and modules according to needs. Module completion means dividing the projectile structure of the device into different functional units or modules to complete all or part of the functions described above.

The above-described embodiments are only used to illustrate the technical solutions of the present disclosure, but not to limit thereto. Although the present disclosure has been described in detail with reference to the foregoing embodiments, those of ordinary skill in the art should understand that they can still implement the above-mentioned implementations. The technical solutions described in the examples are modified, or some of the technical features are equivalently replaced; and these modifications or substitutions do not cause the essence of the corresponding technical solutions to deviate from the spirit and scope of the technical solutions of each embodiment of the present disclosure, and should be included in within the protection scope of the present disclosure.

What is claimed is:

1. A muzzle flash simulator configured to be installed on a toy air gun, the muzzle flash simulator comprising:
a base;
a vibration sensor disposed on the base and communicatively connected to a controller, and configured to transmit a trigger signal to the controller when the toy air gun is detected in a vibrating state;
wherein the controller is preset to output at least two control signals that periodically change according to the trigger signal; and
at least one group of flash simulation light sources connected to the controller and configured to periodically emit lights having different colors to a projectile launched from the toy air gun according to the control signals to form a light track.

2. The muzzle flash simulator according to claim 1, wherein a rail structure is provided on the base, and the muzzle flash simulator is configured to be detachably installed on the toy air gun through the rail structure.

3. The muzzle flash simulator according to claim 2, wherein the rail structure is provided on a side of the base, and a protruding structure matching the rail structure is provided on a side of the toy air gun.

4. The muzzle flash simulator according to claim 1, wherein a threaded structure is provided on the base, and the muzzle flash simulator is configured to be detachably installed at a muzzle of the toy air gun through the threaded structure.

5. The muzzle flash simulator according to claim 1, wherein the at least one group of flash simulation light sources includes at least one group of light-emitting elements, wherein each of the at least one group of light-emitting elements includes at least two light-emitting elements having different colors;
wherein the controller includes a signal generator circuit preset to output the at least two control signals that periodically change to correspondingly control turn-on, turn-off and luminous brightness of the at least two light-emitting elements having different colors.

6. The muzzle flash simulator according to claim 5, wherein a ratio of a positive voltage duration of the control signal to a period within a cycle is constant.

7. The muzzle flash simulator according to claim 6, wherein the positive voltage duration is calculated by the following formula:
$$3 T / 2 n$$
where T is the period, T is less than 0.1 seconds, n is a number of colors of the light-emitting elements, and n is greater than 1.

8. The muzzle flash simulator according to claim 5, wherein a phase difference between two adjacent control signals is calculated by the following formula:
$$360 ° / n$$
where n is a number of colors of the light-emitting elements, and n is greater than 1.

9. A light track generation method applied to the muzzle flash simulator as claimed in claim 1, the light track generation method comprising the following steps:
when the toy air gun is detected in the vibrating state, the vibration sensor is configured to generate the trigger signal and transmit the trigger signal to the controller;
the controller is preset to generate and output the at least two control signals that periodically change according to the trigger signal; and
the at least one group of flash simulation light sources is configured to receive the control signals and periodically emit lights having different colors to the projectile launched from the toy air gun according to the control signals, so as to generate a corresponding light track according to a running trajectory of the projectile.

10. The light track generation method according to claim 9, wherein the steps of generating the trigger signal and transmitting the trigger signal to the controller includes:
determining whether or not the toy air gun launches the projectile; and
if yes, generating the trigger signal and transmitting the trigger signal to the controller.
